(19) United States
(12) Patent Application Publication
(10) Pub. No.: US 2006/0132425 A1
(43) Pub. Date: Jun. 22, 2006

(54) Display device

(75) Inventors: Jae-Kwang Kim, Seoul (KR); Deuk-Soo Kim, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/311,189

(22) Filed: Dec. 19, 2005

(30) Foreign Application Priority Data
Dec. 20, 2004 (KR) 10-2004-0109053

(51) Int. Cl. G09G 3/36

(52) U.S. Cl. 345/104

(57) ABSTRACT

A display device is provided, which includes: first and second panel units; a first connector attached to one side of the first panel unit; a second connector attached to one side of the second panel unit; and a flexible printed circuit film attached to a portion of the first connector and a portion of the second connector.

### BACKGROUND OF THE INVENTION

1. Technical Field

The present invention relates to a display device, and more particularly, to a display device having dual display panel units.

2. Discussion of the Related Art

Recently, flat panel displays, which are lighter and thinner than traditional television and video displays using cathode ray tubes (“CRTs”), have been developed. Some of the more common flat panel displays include: organic light emitting diode (“OLED”) displays, plasma display panels (“PDPs”), and liquid crystal displays (“LCDs”).

Of the common flat panel displays, PDPs display characters or images using plasma generated by a gas-discharge and OLED displays display characters or images by applying an electric field to specific light-emitting organics or high molecule materials. LCDs, on the other hand, display characters or images by applying an electric field to a liquid crystal layer disposed between two panels while regulating the strength of the electric field to adjust a transmittance of light passing through the liquid crystal layer.

More recently, small and medium sized LCDs have found increasing use in portable communications terminals such as folding dual display mobile phones. These so-called dual display devices have display panel units on each of their inner and outer sides.

For example, a dual display device includes a main panel unit mounted on its inner side, a subsidiary panel unit mounted on its outer side, a driving flexible printed circuit film (FPC) provided with signal lines to transmit input signals from external devices, an auxiliary FPC to connect the main panel unit to the subsidiary panel unit, and an integration chip which controls the display device.

In more detail, the integration chip generates control signals and driving signals for controlling the main panel unit and the subsidiary panel unit and is generally mounted on the main panel unit using a COG (chip on glass) method.

In the dual display device, the auxiliary FPC is attached to the top of the main panel unit, the subsidiary panel unit is attached to the auxiliary FPC, and the driving FPC is attached to the bottom of the main panel unit.

In this configuration, the auxiliary FPC tends to have a pitch, which corresponds to a width between its signal lines, of less than 50 μm. Thus, the signal lines are very compact and any discontinuities between the signal lines of the auxiliary FPC, and signal lines of the main and subsidiary panel units become difficult to detect prior to attachment of the main and subsidiary panel units. Further, even if discontinuities are detected after attachment, the auxiliary FPC must be detached for repair.

Additionally, signal lines for transmitting signals to the subsidiary panel unit are typically only disposed at either side of the subsidiary panel unit. As such a need exists for a dual display device having signal lines that are easily configured and repaired.

### SUMMARY OF THE INVENTION

According to an exemplary embodiment of the present invention, a display device is provided, which includes: first and second panel units; a first connector attached to one side of the first panel unit; a second connector attached to one side of the second panel unit; and a flexible printed circuit film attached to a portion of the first connector and a portion of the second connector.

The second connector may be attached to the flexible printed circuit film through an area formed by cutting a portion of the flexible printed circuit film. The second panel unit may be positioned in the area.

Each of the first and second panel units may include pixels, each pixel comprising a switching element connected to a first and second display signal line.

The display device may further include: a gate driver generating gate signals for application to the first display signal lines; and a data driver generating data voltages for application to the second display signal lines.

The display device may further include a driving circuit driving the first and the second panel units. The driving circuit may include the gate driver and the data driver. The driving circuit may be mounted on the first panel unit.

The switching elements may comprise poly silicon or amorphous silicon.

The flexible printed circuit film may include first and second power supply units respectively providing power to the first and second panel units.

According to another exemplary embodiment of the present invention, a display device is provided, which includes: a first panel unit comprising a peripheral area defining a first display area; a second panel unit comprising a peripheral area defining a second display area; a first connector attached to one side of the first panel unit; a second connector attached to one side of the second panel unit; and a flexible printed circuit film attached to a portion of the first connector and a portion of the second connector.

The portion of the second connector is attached to the flexible printed circuit film through an aperture formed by cutting a portion of the flexible printed circuit film. The second panel unit is positioned in the aperture.

Each of the first and second panel units comprises a pixel, each pixel comprising a switching element connected to a first and second display signal line.

The display device further includes: a gate driver generating gate signals for application to the first display signal lines; and a data driver generating data voltages for application to the second display signal lines. The switching elements comprise poly silicon or amorphous silicon.

The display device further includes a driving circuit driving the first and second panel units. The driving circuit comprises the gate driver and the data driver. The driving circuit is mounted on the first panel unit.

The flexible printed circuit film comprises a first power supply unit providing power to the first panel unit and a second power supply unit providing power to the second panel unit.

The first and second display areas may include an LCD display.

### BRIEF DESCRIPTION OF THE DRAWINGS

The above and other features of the present invention will become more apparent by describing in detail exemplary embodiments thereof with reference to the accompanying drawings, in which:

FIG. 1 is a block diagram of a display device according to an exemplary embodiment of the present invention;

FIG. 2 illustrates an equivalent circuit diagram of a pixel of a liquid crystal display (LCD) according to an exemplary embodiment of the present invention; and

FIG. 3 is a schematic view of a display device according to an exemplary embodiment of the present invention.

### DETAILED DESCRIPTION OF EXEMPLARY EMBODIMENTS

The present invention will now be described more fully hereinafter with reference to the accompanying drawings, in which exemplary embodiments of the invention are shown. This invention may, however, be embodied in many different forms and should not be construed as limited to the exemplary embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

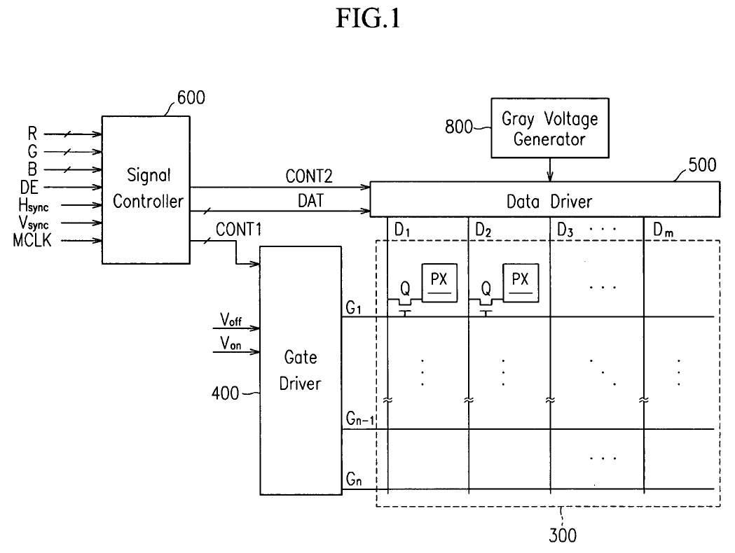

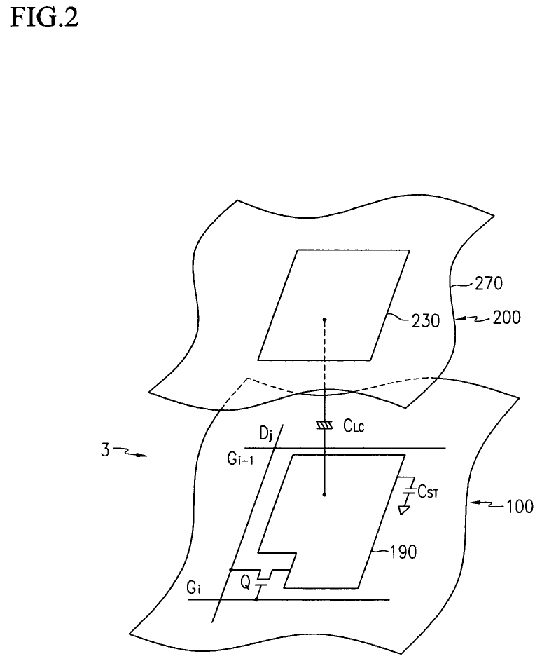

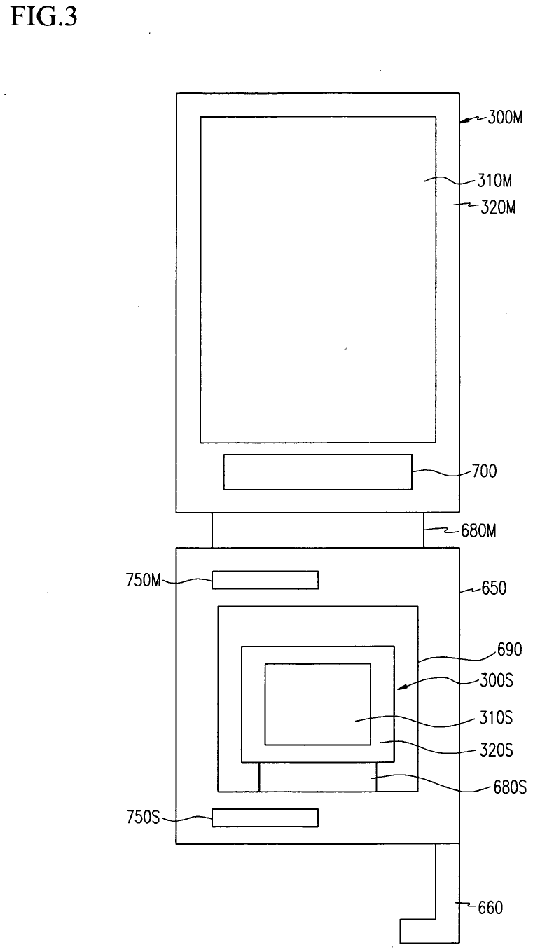

FIG. 1 is a block diagram of a display device according to an exemplary embodiment of the present invention, FIG. 2 illustrates an equivalent circuit diagram of a pixel of an LCD according to an exemplary embodiment of the present invention, and FIG. 3 is a schematic view of a display device according to an exemplary embodiment of the present invention.

Referring to FIG. 1, the display device includes a panel unit 300, a gate driver 400 and a data driver 500 connected thereto. The display device also includes a gray voltage generator 800 connected to the data driver 500, and a signal controller 600 for controlling the display device.

The panel unit 300 includes a plurality of display signal lines G₁-Gₙ and D₁-Dₘ, and a plurality of pixels connected thereto and arranged substantially in a matrix. The panel unit 300 includes a lower panel 100 and an upper panel 200 as shown in FIG. 2.

Referring now to FIGS. 1 and 2, the display signal lines G₁-Gₙ and D₁-Dₘ are provided on the lower panel 100 and include gate lines G₁-Gₙ for transmitting gate signals (called scanning signals) and data lines D₁-Dₘ for transmitting data signals. The gate lines G₁-Gₙ extend substantially in a row direction and are substantially parallel to each other, while the data lines D₁-Dₘ extend substantially in a column direction and are substantially parallel to each other.

Each pixel includes a switching element Q connected to one of the gate lines G₁-Gₙ and one of the data lines D₁-Dₘ, and pixel circuits PX connected to the switching element Q. The switching element Q is provided on the lower panel 100 and has three terminals: a control terminal connected to one of the gate lines G₁-Gₙ; an input terminal connected to one of the data lines D₁-Dₘ; and an output terminal connected to the pixel circuit PX.

In, for example, a flat panel display such as an active matrix LCD, the panel unit 300 includes the lower panel 100, the upper panel 200, and a liquid crystal (LC) layer 3 disposed between the lower and upper panels 100 and 200 with the display signal lines G₁-Gₙ and D₁-Dₘ and the switching elements Q provided on the lower panel 100.

As shown in FIG. 2, each pixel circuit PX includes an LC capacitor C_{LC} and a storage capacitor C_{ST} that are connected in parallel with the switching element Q. The storage capacitor C_{ST} may be omitted if the storage capacitor C_{ST} is not needed.

The LC capacitor C_{LC} includes a pixel electrode 190 on the lower panel 100, a common electrode 270 on the upper panel 200, and the LC layer 3 acting as a dielectric between the pixel and common electrodes 190 and 270. The pixel electrode 190 is connected to the switching element Q, and the common electrode 270 covers the entire surface of the upper panel 200 and is supplied with a common voltage Vcom. Alternatively, both the pixel electrode 190 and the common electrode 270, which may be shaped as bars or stripes, can be provided on the lower panel 100.

Still referring to FIG. 2, the storage capacitor C_{ST} is an auxiliary capacitor for the LC capacitor C_{LC}. The storage capacitor C_{ST} includes the pixel electrode 190 and a separate signal line (not shown), which is provided on the lower panel 100 and overlaps the pixel electrode 190 with an insulator disposed between the pixel electrode 190 and the separate signal line. The storage capacitor C_{ST} is supplied with a predetermined voltage such as the common voltage Vcom. Alternatively, the storage capacitor C_{ST} includes the pixel electrode 190 and an adjacent gate line called a previous gate line, which overlaps the pixel electrode 190 with an insulator disposed between the pixel electrode 190 and the previous gate line.

For color display, each pixel uniquely represents one of three primary colors such as red, green, and blue (e.g., spatial division), or sequentially represents the three primary colors in time (e.g., temporal division), thereby obtaining a desired color. FIG. 2 shows an example of the spatial division in which each pixel includes a color filter 230 representing one of the three primary colors in an area of the upper panel 200 facing the pixel electrode 190. Alternatively, the color filter 230 may be provided on or under the pixel electrode 190 on the lower panel 100.

A pair of polarizers (not shown) for polarizing light are also attached on outer surfaces of the lower and upper panels 100 and 200 of the panel unit 300.

As shown in FIG. 3, the display device includes two panel units such as a main panel unit 300M and a subsidiary panel unit 300S. Each of the panel units 300M and 300S includes a peripheral area 320M and 320S defining a display area 310M and 310S in which the pixels and a majority of the display signal lines G₁-Gₙ and D₁-Dₘ are provided. In addition, the upper panel 200 may be smaller than the lower panel 100, such that the lower panel 100 has an exposed area into which the data lines D₁-Dₘ are extended to connect to a data driver 500 of FIG. 1.

The main panel unit 300M and the subsidiary panel unit 300S are attached to an FPC 650 via a main connector 680M and a subsidiary connector 680S.

In detail, the main panel unit 300M is attached at one side of the FPC 650 via the main connector 680M, and the subsidiary panel unit 300S is attached at one side of an aperture 690 which is formed by cutting a portion of the FPC 650, via the subsidiary connector 680S.

It is to be understood by one of ordinary skill in the art that the FPC 650 is also called an interface FPC and is provided with signal lines (not shown) for transmitting signals, and pads (not shown) positioned at an end portion of the signal lines. Additionally, pads are also provided in the connectors 680M and 680S which are in contact with the pads of the FPC 650 and pads of the panel units 300M and 300S.

Further, the FPC 650 is provided with power supply units 750M and 750S for providing a constant current or voltage to the main panel unit 300M and the subsidiary panel unit 300S, respectively. The power supply units 750M and 750S each include power circuits and resistors.

The pads of the FPC 650, the pads of the connectors 680M and 680S, and the pads of each of the panel units 300M and 300S are electrically connected to each other by soldering or by using an anisotropic conductive film (ACF).

In this way, attachment of the subsidiary panel unit 300S to a single FPC 650 reduces the longitudinal size of the display device. Moreover, since the subsidiary panel unit 300S is not attached to the top of the main panel unit 300M, the signal lines for transmitting signals to the subsidiary panel unit 300S are not disposed at the main panel unit 300M.

Thus, the transverse size of the display device is reduced, thereby enabling a smaller sized display device to be designed. Additionally, by using a single FPC, manufacturing costs of the display device can be reduced. Further, the connectors 680M and 680S allow the panel units 300M and 300S to be easily detached for repair when, for example, signal lines of the FPC 650 are faulty.

Referring back to FIG. 1, a gray voltage generator 800 generates one or two sets of gray voltages related to a transmittance of the pixels. When, for example, two sets of the gray voltages are generated, the gray voltages in one set have a positive polarity with respect to the common voltage Vcom, while the gray voltages in the other set have a negative polarity with respect to the common voltage Vcom.

The gate driver 400 synthesizes a gate-on voltage Von and a gate-off voltage Voff to generate gate signals for application to the gate lines G₁-Gₙ. The gate driver is a shift register, which includes a plurality of stages in a line.

The data driver 500 is connected to the data lines D₁-Dₘ and applies data voltages selected from the gray voltages supplied from the gray voltage generator 800 to the data lines D₁-Dₘ.

The signal controller 600 controls the gate driver 400 and the data driver 500. The signal controller 600, the data driver 500, and the gray voltage generator 800 are implemented by a single integration chip 700 shown in FIG. 3 to be mounted on the main panel unit 300M using a COG (chip on glass) method.

As shown in FIG. 3, the integration chip 700 receives signals from an external device via an input unit 660, and provides processed signals for the main and the subsidiary panel units 300M and 300S via signal lines provided on the FPC 650.

Now, the operation of the display device will be described in detail referring to FIG. 1.

As shown in FIG. 1, the signal controller 600 is supplied with image signals R, G, and B and input control signals for controlling the display of the image signals R, G, and B on the panel unit 300. The input control signals include, for example, a vertical synchronization signal Vsync, a horizontal synchronization signal Hsync, a main clock MCLK, and a data enable signal DE, input from an external graphics controller (not shown).

After generating gate control signals CONT1 and data control signals CONT2 and processing the image signals R, G, and B to be suitable for the operation of the panel unit 300 in response to the input control signals, the signal controller 600 provides the gate control signals CONT1 to the gate driver 400 and the processed image signals DAT and the data control signals CONT2 to the data driver 500.

The gate control signals CONT1 include a vertical synchronization start signal STV for informing the gate driver 400 of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply the appropriate data voltages to the data lines D₁-Dₘ, and a data clock signal HCLK. The data control signals CONT2 may further include an inversion control signal RVS for reversing the polarity of the data voltages with respect to the common voltage Vcom.

The data driver 500 receives the processed image signals DAT for a pixel row from the signal controller 600, and converts the processed image signals DAT into analog data voltages selected from the gray voltages supplied from the gray voltage generator 800 in response to the data control signals CONT2 from the signal controller 600.

In response to the gate control signals CONT1 from the signal controller 600, the gate driver 400 applies the gate-on voltage Von to the gate lines G₁-Gₙ, thereby turning on the switching elements Q connected to the gate lines G₁-Gₙ.

The data driver 500 applies the data voltages to corresponding data lines D₁-Dₘ for a turn-on time of the switching elements Q. The turn-on time of the switching elements Q is called “one horizontal period” or “1H” and equals one period of the horizontal synchronization signal Hsync, the data enable signal DE, and the gate clock signal CPV. The data voltages in turn are supplied to corresponding pixels via the turned-on switching elements Q.

The difference between the data voltage and the common voltage Vcom applied to a pixel is expressed as a charged voltage of the LC capacitor C_{LC}, e.g., a pixel voltage. Liquid crystal molecules of, for example, the LC layer 3, have orientations depending on a magnitude of the pixel voltage, and the orientations determine a polarization of light passing through the LC capacitor C_{LC}. The polarizers convert light polarization into light transmittance.

By repeating the above-described procedures, all of the gate lines G₁-Gₙ are sequentially supplied with the gate-on voltage Von during a frame, thereby applying the data voltages to all pixels. Thus, in the LCD shown in FIG. 1, when a next frame starts after finishing one frame, the inversion control signal RVS applied to the data driver 500 is controlled such that a polarity of the data voltages is reversed (this is referred to as “frame inversion”). In addition, the inversion control signal RVS may be controlled such that the polarity of the data voltages flowing in a data line in one frame is reversed (this is referred to as “row inversion” and “dot inversion”), or the polarity of the data voltages in one packet is reversed (this is referred to as “column inversion” and “dot inversion”).

Meanwhile, in FIG. 3, since both of the panel units 300M and 300S are driven by the integration chip 700, power consumption may increase. However, power consumption of the display device may be reduced by alternately driving the main panel unit 300M and the subsidiary panel unit 300S. For example, switching elements such as transmission gates may be provided on each of the panel units 300M and 300S and control signals for turning on/off the transmission gates can be applied thereto. In addition, gate signals may be alternately applied to the gate driver of each of the panel units 300M and 300S.

While the present invention has been described in detail with reference to the exemplary embodiments, it is to be understood by those of ordinary skill in the art that various changes in form and details may be made therein without departing from the sprit and scope of the present invention as defined by the appended claims.

What is claimed is:

1. A display device, comprising:
first and second panel units;
a first connector attached to one side of the first panel unit;
a second connector attached to one side of the second panel unit; and
a flexible printed circuit film attached to a portion of the first connector and a portion of the second connector.

2. The display device of claim 1, wherein the portion of second connector is attached to the flexible printed circuit film through an area formed by cutting a portion of the flexible printed circuit film.

3. The display device of claim 2, wherein the second panel unit is positioned in the area.

4. The display device of claim 1, wherein each of the first and second panel units comprises a pixel, each pixel comprising a switching element connected to a first and second display signal line.

5. The display device of claim 4, further comprising:
a gate driver generating gate signals for application to the first display signal lines; and
a data driver generating data voltages for application to the second display signal lines.

6. The display device of claim 5, further comprising:
a driving circuit for driving the first and second panel units.

7. The display device of claim 6, wherein the driving circuit comprises the gate driver and the data driver.

8. The display device of claim 7, wherein the driving circuit is mounted on the first panel unit.

9. The display device of claim 4, wherein the switching elements comprise poly silicon.

10. The display device of claim 4, wherein the switching elements comprise amorphous silicon.

11. The display device of claim 1, wherein the flexible printed circuit film comprises a first power supply unit providing power to the first panel unit and a second power supply unit providing power to the second panel unit.

12. A display device, comprising:
a first panel unit comprising a peripheral area defining a first display area;
a second panel unit comprising a peripheral area defining a second display area;
a first connector attached to one side of the first panel unit;
a second connector attached to one side of the second panel unit; and
a flexible printed circuit film attached to a portion of the first connector and a portion of the second connector.

13. The display device of claim 12, wherein the portion of the second connector is attached to the flexible printed circuit film through an aperture formed by cutting a portion of the flexible printed circuit film.

14. The display device of claim 13, wherein the second panel unit is positioned in the aperture.

15. The display device of claim 12, wherein each of the first and second panel units comprises a pixel, each pixel comprising a switching element connected to a first and second display signal line.

16. The display device of claim 15, further comprising:
a gate driver generating gate signals for application to the first display signal lines; and
a data driver generating data voltages for application to the second display signal lines.

17. The display device of claim 16, further comprising:
a driving circuit for driving the first and second panel units.

18. The display device of claim 17, wherein the driving circuit comprises the gate driver and the data driver.

19. The display device of claim 18, wherein the driving circuit is mounted on the first panel unit.

20. The display device of claim 15, wherein the switching elements comprise poly silicon.

21. The display device of claim 15, wherein the switching elements comprise amorphous silicon.

22. The display device of claim 12, wherein the flexible printed circuit film comprises a first power supply unit providing power to the first panel unit and a second power supply unit providing power to the second panel unit.

23. The display device of claim 12, wherein the first and second display areas comprise an LCD display.
